(19) United States
(12) Patent Application Publication
(10) Pub. No.: US 2005/0214546 A1
(43) Pub. Date: Sep. 29, 2005

(54) Method for the production of a mineral substrate with modified surface and substrate thus obtained

(76) Inventors: Gerard Lanneau, Teyran (FR); Michel Granier, Teyran (FR); Johanne Moineau, Chef-Boutonne (FR)

Correspondence Address: E Joseph Gess;Burns Doane Swecker & Mathis, P O Box 1404, Alexandria, VA, 22313-1404, US

(21) Appl. No.: 10/516,243

(22) PCT Filed: May 20, 2003
(86) PCT No.: PCT/FR03/01515

§ 371 Date: May 24, 2005

(51) Int. Cl. B32B 9/04

(52) U.S. Cl. 428/447; 427/372.2

(57) ABSTRACT

Provided is a method for the production of a mineral substrate with a surface modified by organic groups. The method comprises placing the surface of a mineral substrate with silanol functional groups in contact with a solution of an organotrihydrosilane in an organic solvent at a temperature of less than 30 ° C. The mineral substrate with silanol functions can comprise silica particles, a sheet of glass, quartz or mica as well as silicon of the wafer type covered by a layer of silica deposited by an appropriate preliminary treatment.

The present invention relates to a process for the production of an inorganic substrate which is surface-modified by organic groups, and the modified substrates obtained.

The use of coupling agents, which make it possible to improve adhesion between an organic matrix and an inorganic substrate by forming an intermediate film, is increasingly widespread. Self-assembled monolayers, called SAMs, which are formed by aliphatic long-chain organic molecules on a silica substrate, constitute an alternative to the films formed by physisorption according to the Langmuir-Blodgett technique. These SAM monolayers possess great stability and resistance to various disruptions, in particular to corrosion and to the presence of solvents, because the organic molecules are attached to the silica by covalent bonds.

Various techniques for grafting an organic layer onto the surface of a silica substrate are known: organization of the layer by physisorption, for example grafting of an alkane onto a gold or silver substrate, starting with alkanediols; organization of the layer by chemisorption, for example grafting of an alkane onto a platinum substrate starting with alcohols or amines, or onto an alumina substrate starting with carboxylic acid; grafting of organic groups onto a substrate containing surface OH groups, by covalent bonding starting with organosilanes such as alkylchlorosilanes, alkylalkoxysilanes or alkylaminosilanes (cf. in particular A. Ulman, Chem. Rev., 1996, 96, 1533-1554). In a method for grafting organic groups onto a silica substrate carrying Si—OH groups, starting with organotrichlorosilanes, hydrochloric acid is formed which catalyzes both the hydrolysis reaction which causes the attachment of the organosilane to the surface of this substrate, and the homocondensation of organosilanes with each other. The overall process is thus accelerated at the expense of selectivity. In the case of short-chain organochlorosilanes, which are the silanes most widely used in industrial applications, the deposits obtained are in the form of multilayers whose thickness is difficult to control. When an organotrialkoxysilane is used, the corresponding alcohol, which can become adsorbed to the surface of the substrate, is formed, causing an increase in the heterogeneity of the grafting.

Through E. Lukevics et al., (J. Organomet. Chem. 1984, 271, 307), processes are known which consist in reacting organosilanes with compounds having an active hydrogen, such as acids, alcohols and thiols. This process requires, however, the use of a catalyst, for example a Lewis base, or of a nucleophilic solvent.

Through A. Fadeev, et al., (J. Am. Chem. Soc. 1999, 121, 12184), a process is known which consists in reacting an organosilane RSiH₃, R₂SiH₂ or R₃SiH with titanium oxide. Through A. Ulman et al., (Chem. Mat. 2002, 14, 1778), a process is known which consists in reacting octadecyltrihydrosilane with γ-Fe₂O₃ particles. The films obtained according to these processes are not very stable because the reactions result in the formation of labile Si—O-M bonds (M being depending on the case Ti or Fe), which can be redistributed as Si—O—Si+M-O-M which are more stable.

The aim of the present invention is to provide a process for the production of silica substrates which are surface-modified by deposition of a homogeneous and well-organized dense layer.

The process according to the invention consists in bringing an inorganic substrate carrying silanol functional groups at its surface into contact with a solution of an organotrihydrosilane in an organic solvent, at a temperature of less than 30° C.

As an example of an inorganic substrate carrying silanol functional groups at its surface, there may be mentioned in particular silica particles, glass plates, quartz plates or mica plates, and wafer-type silicon coated with a silica layer deposited by an appropriate preliminary treatment.

A wafer-type silicon substrate carrying a silica layer at its surface may be obtained according to various processes. A first process consists in removing the native silica layer by immersing the silicon substrate in a solution of HF containing at least 10% by volume of HF in ultrapure water under ultrasound, in rinsing with ultrapure water, and then in treating with ozone under UV. Such a treatment, which is particularly preferred, is described in particular by J. R. Vig, J. Vac. Sci. Technol., 1985, 3, 1027-1034. A second process consists in subjecting said silicon substrate to an oxygen stream at high temperature, for example at 1150° C., as described in particular by D. L. Angst, Langmuir, 1991, 7, 2236-2242. In another process, the silicon substrate is subjected to a chemical oxidation by the basic route: after cleaning the surface of the substrate with a solvent under ultrasound, the substrate is left in an H₂O, NH₄OH, H₂O₂ 5/1/1 mixture, and then rinsed with deionized water, dried and rehydrated (cf. for example “J. D. Legrange, et al., Langmuir, 1993, 9, 1749-1753”). In another process, the silicon substrate is subjected to a chemical oxidation by the acidic route: the substrate is cleaned with a basic solution, and then dipped in an acidic mixture of the H₂SO₄/H₂O₂ type (cf. A. K. Kakkar, et al., Langmuir, 1998, 14, 6941-6947).

The grafting step itself, that is to say the bringing of the organotrihydrosilane and the silica substrate into contact, is performed in a neutral atmosphere (preferably under argon), using a solution of organotrihydrosilane in an aprotic solvent. Among the aprotic solvents, it is preferable to use those which have a low hygroscopic character. By way of example, there may be mentioned carbon tetrachloride, trichloroethylene and toluene.

The organotrihydrosilane may be chosen from the compounds X-E-SiH₃ in which E is a spacer segment and X represents H or a reactive terminal functional group.

X may be chosen from any functional group capable of allowing the attachment of other organic groups (for example an amine group, a halogen, an epoxy, a pyridyl, an ester, a tosylate (p-toluenesulfonyl), a heterocumulene (such as an isocyanate, an isothiocyanate or a carbodiimide) or a metal-complexing agent (for example a crown ether, a cryptant, a calixarene which is a macrocycle obtained by condensation of a phenolic derivative with formaldehyde).

The spacer group E makes it possible to confer particular properties to the film obtained using the process. The group E is chosen from radicals which make it possible to obtain an organized monolayer. A radical E of the long-chain alkylene type allows interchain interaction. Among the radicals E of the alkylene type, those particularly preferred have from 8 to 24 carbon atoms. A radical E comprising two —C≡C— triple bonds allows crosslinking. A radical E comprising a conjugated aromatic chain confers nonlinear optical properties. By way of example, there may be mentioned phenylene-vinylene and phenylene-acetylene radicals. A radical E of the pyrrole, thiophene or polysilane type confers electronic conduction. A radical E of the heterosubstituted polyaromatic type confers photo/electroluminescence properties. By way of example, there may be mentioned quinones and diazo compounds. A group E of the alkyl or fluoroalkyl type, in particular an alkyl or fluoroalkyl group having from 3 to 24 carbon atoms, makes it possible to use the layers obtained in chromatography or in electrophoresis.

The organotrihydrosilane solution preferably contains from 10⁻³ to 10⁻¹ mole/1. Solutions in which the organotrihydroxilane concentration is of the order of 10⁻² mole/1 are particularly preferred.

The duration of grafting is preferably between 4 and 24 hours. A duration of the order of 12 h makes it possible to obtain good results.

During grafting, the reaction medium should be kept at a temperature of less than 30° C. The maximum value depends on the substituent X-E-. This maximum value tends to decrease when the number of carbon atoms of the substituent decreases. The determination of the maximum value for a given substituent is within the capability of persons skilled in the art. Useful information may be found in particular in Brzoska et al., (Langmuir, 1994, 10, 4367), which mentions the existence of a critical temperature Tc controlling the quality of the self-assembled monolayers obtained from various alkyltrichlorosilanes. The maximum temperature is generally less than 30° C. For example, the temperature should be less than 30° C. if R is C₁₈H₃₇ and less than 10° C. if R is C₁₂H₂₅.

It is preferable to carry out the reaction under an inert atmosphere, in order to avoid pollution of the monolayer with organic compounds.

The use of an organosilane X-E-SiH₃ as coupling agent allows the initial formation of an Si—O—Si bond by direct condensation between the Si—H functional group of the reagent with a silanol Si—OH functional group carried by the surface of the substrate. This grafting mode considerably limits the formation of aggregates, which are damaging to the deposition of a homogeneous layer. The use of X-E-SiH₃ additionally has the advantage of producing by-products which are easy to remove, namely H₂. There is no risk of finding on the treated substrate anionic entities or protic compounds inherent to prior art processes using chlorosilanes or alkoxysilanes.

It should also be noted that the process proposed may be carried out without using a catalyst, unlike the prior art processes consisting in reacting organosilanes with compounds having an active hydrogen, such as acids, alcohols or thiols (cf. E. Lukevics et al., cited above).

The silica substrate modified according to the process of the present invention contains at its surface a monolayer of segments X-E- attached by a covalent bond Si—O—Si, said layer containing functional groups X which are uniformly distributed on the surface and which are accessible.

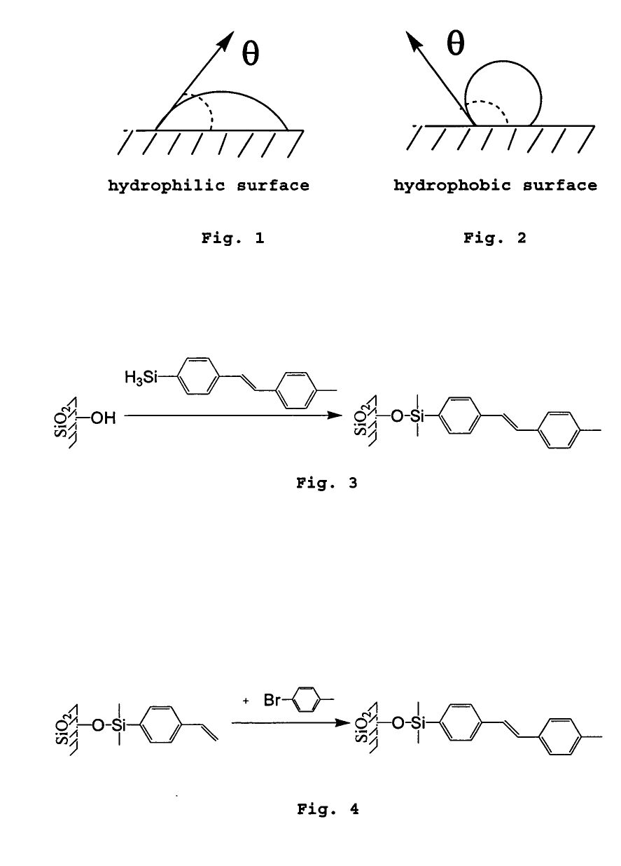

The process of the invention consists in depositing an organic monolayer on a surface layer of silica which is initially very hydrophilic, the angle of contact being less than 10°. After grafting, the wettability of the surface toward ultrapure water greatly depends on the nature of the groups X-E- of the silane used to form the layer. In the case of alkylsilanes (E being a linear alkylene), the hydrophobic character of the surface results in an angle of contact θ_{H20}≈95-100°. When E is an aryl, the presence of aromatic groups reduces the hydrophobic character of the surface, which results in an angle of contact θ_{H20}≈69-77°. FIG. 1 illustrates the state of a drop of water on a hydrophilic surface, the angle θ being less than 90°. FIG. 2 illustrates the state of a drop of water on a hydrophobic surface, the angle θ being greater than 90°.

The images obtained by AFM (atomic force microscopy) show that the surface is homogeneous and has a very low mean surface roughness (MSR), generally of less than 0.2 nm. The roughness of the treated substrate is independent of the nature of the organic group grafted, it remains very close to that of the untreated initial substrate.

The thickness of the layer obtained is determined by ellipsometry (taking n=1.45 as the value of the refractive index of the surface film, which is the value generally used). This thickness depends on the length of the group X-E- and on its orientation relative to the surface of the substrate. The thickness is of the order of 1.7 nm when X-E- is octadecyl, which corresponds to a dispersed layer occupying≅70% of the surface of the substrate.

The substrate coated with a monolayer obtained by the proposed process is characterized in general by a good covering rate and a good organization of the chains at its surface.

In a substrate modified using a silane of the alkyl-SiH₃ type, the covalent bond through which the substrate is attached to the organic group is of the —SiH₂O—Si— type. The presence of SiH₂ groups is revealed by the vibration band √Si—H at 2150 cm⁻¹. This band is not observed on the substrates modified according to the prior art processes with the aid of an alkyltrichlorosilane or an alkyltrialkoxysilane comprising the same alkyl group.

The present invention is described in greater detail with the aid of the following examples, to which it is, however, not limited.

### EXAMPLE 1

A series of silicon substrates coated with an organic layer were prepared by treatment with octadecyltrihydrosilane.

As substrate, silicon (100) disks cut in order to obtain 1×2 cm² rectangular platelets were used.

In a first stage, each platelet was immersed in a solution of concentrated HF for a few seconds, until the surface became completely hydrophobic. Next, each platelet was rinsed with ultrapure water, and then treated with ozone under UV.

Each platelet thus treated was immediately introduced into a Schlenck tube containing 20 ml of a 10⁻²M solution of octadecyltrihydrosilane in CCl₄, and kept in the tube for 24 h at a temperature of 15° C., without stirring. After 24 h, the platelets were extracted from the Schlenck tubes, washed with CCl₄, with absolute ethanol, and then with chloroform, each washing being carried out under ultrasound, for a period of the order of 5 min.

The platelets thus obtained may be stored in an ambient atmosphere, without undergoing degradation.

The angle of contact at the surface of the platelets, measured by the drop method at equilibrium, is 98°±2, which indicates a hydrophobic and homogeneous surface.

Under the same conditions as above, silicon platelets were treated with the aid of octadecyltrichlorosilane, for comparison.

Analysis by infrared spectroscopy in attenuated total reflection (ATR) mode of the surfaces treated with octadecyltrihydrosilane and of the surfaces treated with octadecyltrichlorosilane gave the results grouped together in the following table.

| | C₁₈H₃₇SiH₃ | C₁₈H₃₇SiH₃ | C₁₈H₃₇SiCl₃ | C₁₈H₃₇SiCl₃ |
|---|---|---|---|---|
| | solution | grafted | grafted | solution |
| √ₐₛCH₃ (cm⁻¹) | 2958 | 2959 | 2959 | 2958 |
| √ₛCH₃ (cm⁻¹) | 2872 | 2873 | 2874 | 2872 |
| √ₐₛCH₂ (cm⁻¹) | 2927 | 2922 | 2918 | 2927 |
| √ₛCH₂ (cm⁻¹) | 2855 | 2850 | 2850 | 2855 |
| √Si—H (cm⁻¹) | 2148 | 2150 | — | — |

The substrates treated according to the invention have a band √Si—H at 2150 cm⁻¹ which does not exist for the substrates obtained from C₁₈H₃₇SiCl₃ and which corresponds to the existence of Si—H bonds in an environment of the R—SiH₂—O type at the surface of the substrate.

The other bands obtained show that the organization of octadecyltrihydrosilane at the surface is a compromise between a complete crosslinking obtained for octadecyltrichlorosilane grafted and the absence of organization observed for octadecyltrihydrosilane and for octadecyltrichlorosilane in solution.

The images obtained by AFM for the platelets of the invention show a homogeneous surface with a very low roughness, of the order of 0.15-0.20 nm.

The thickness of the layers obtained according to the process of the invention was determined by ellipsometry, taking n=1.45 as the value of the refractive index. This thickness is of the order of 1.7 nm, which corresponds to a dispersed layer occupying 70% of the surface of the substrate.

### EXAMPLE 2

The procedure of example 1 was repeated using octadecyltrihydrosilane, changing only the reaction temperature in the Schlenck tube. Two series of trials were performed at 5° C. and at 20° C., respectively. The analyses carried out on the platelets gave identical results.

### EXAMPLE 3

The procedure of example 1 was repeated, but replacing octadecyltrihydrosilane with phenyltrihydrosilane, all the other conditions being identical.

The angle of contact measured at the surface of the modified platelets is 74°±4.

The images obtained by AFM for the platelets of the invention show a homogeneous surface with a very low roughness, of the order of 0.2 nm.

The thickness of the layers obtained according to the process of the invention was determined by ellipsometry, taking n=1.45 as the value of the refractive index. This thickness is of the order of 0.8 nm, which corresponds to a monolayer of high density.

### EXAMPLE 4

A series of platelets were treated according to the procedure of example 1, but replacing octadecyltrihydrosilane with p-methylstilbenyltrihydrosilane, all the other conditions being identical. FIG. 3 illustrates the state of the surface of the platelet after grafting of the p-methylstilbenyltrihydrosilane.

The angle of contact measured at the surface of the modified platelets is 85°±3.

The images obtained by AFM for the platelets show a homogeneous surface with a very low roughness, of the order of 0.2 nm.

The thickness of the layers obtained was determined by ellipsometry, taking n=1.619 as the value of the refractive index. This thickness is of the order of 19 nm, which corresponds to a monolayer of high density.

### EXAMPLE 5

A series of platelets were treated according to the procedure of example 1, but replacing octadecyltrihydrosilane with vinylphenyltrihydrosilane, all the other conditions being identical.

The angle of contact measured at the surface of the modified platelets is 75°±4.

The images obtained by AFM for the platelets show a homogeneous surface with a very low roughness, of the order of 0.2 nm.

The thickness of the layers obtained was determined by ellipsometry, taking n=1.546 as the value of the refractive index. This thickness is of the order of 11 nm, which corresponds to a monolayer of high density.

Each platelet thus treated was placed in a 25 ml flask surmounted by a condenser and containing 1 mmol of p-bromotoluene, 9 mg (0.04 mmol) of palladium diacetate, 46 mg (0.15 mmol) of triorthotolylphosphine, 2 ml of triethylamine and 10 ml of toluene, the whole under an inert atmosphere. The reaction mixture was heated to 110° C. with gentle magnetic stirring overnight. After returning to room temperature, each platelet was taken out of the flask, and then carefully rinsed with toluene and with pentane under ultrasound. FIG. 4 illustrates the state of the surface of the platelet after post-grafting reaction of p-bromotoluene.

The platelets thus obtained may be stored under an ambient atmosphere, without undergoing degradation.

Analyses carried out on the platelets gave results identical to those obtained for the analyses of the platelets treated in example 4.

### EXAMPLE 6

The process according to the invention was carried out for a silica substrate in the form of colloidal silica.

The substrate is an activated silica marketed by the company Merck under the name Merck 60F silica.

0.5 g of the activated silica was treated with 1 g of octadecyltrihydrosilane in 20 ml of CCl₄ at 19-20° C. for 24 h, with magnetic stirring. The powder obtained was filtered, washed twice with 20 ml of CCl₄, and then 4 times with 20 ml of THF in order to remove any silanes physisorbed.

It is observed that grains of the powder obtained, when deposited at the surface of ultrapure water, remain at the surface after 48 hours, which demonstrates a perfectly hydrophobic character.

The presence of grafted silane is characterized by infrared spectroscopy and NMR. An IR band at 2165 cm⁻¹ and a signal at −31 ppm in ²⁹Si NMR show the presence of —O—SiR(H)—O— functional groups. This result presupposes the hydrolysis of an Si—H bond, following the attachment of the organosilane to the surface.

1. A process for the production of an inorganic substrate which is surface-modified by an organic layer, characterized in that it consists in bringing an inorganic substrate carrying silanol functional groups at its surface into contact with a solution of an organotrihydrosilane in an organic solvent, at a temperature of less than 30° C.

2. The process as claimed in claim 1, characterized in that the inorganic substrate carrying silanol functional groups at its surface is a substrate consisting of silica.

3. The process as claimed in claim 1, characterized in that the inorganic substrate carrying silanol functional groups at its surface is a silicon substrate carrying a silica layer at its surface.

4. The process as claimed in claim 1, characterized in that the inorganic substrate carrying silanol functional groups at its surface is a glass, mica or quartz plate.

5. The process as claimed in claim 1, characterized in that the reaction is carried out in a neutral atmosphere.

6. The process as claimed in claim 1, characterized in that the solvent is an aprotic solvent.

7. The process as claimed in claim 6, characterized in that the solvent is chosen from carbon tetrachloride, trichloroethylene and toluene.

8. The process as claimed in claim 1, characterized in that the organotrihydrosilane corresponds to the formula X-E-SiH₃ in which E is a spacer segment and X represents H or a reactive terminal functional group.

9. The process as claimed in claim 8, characterized in that X represents an amino group, a halogen, an epoxy, a pyridyl, an ester, a tosylate or a heterocumulene.

10. The process as claimed in claim 8, characterized in that X represents a metal-complexing agent.

11. The process as claimed in claim 10, characterized in that X is a crown ether, a cryptant or a calixarene.

12. The process as claimed in claim 8, characterized in that the spacer group E is a long-chain alkylene radical.

13. The process as claimed in claim 8, characterized in that the spacer group E is a hydrocarbon radical comprising two —C≡C— triple bonds.

14. The process as claimed in claim 8, characterized in that the spacer group E comprises a conjugated aromatic chain.

15. The process as claimed in claim 8, characterized in that the spacer group E is a pyrrole, or thiophene.

16. The process as claimed in claim 1, characterized in that the organotrihydrosilane solution contains from 0.001 to 0.1 mole/1.

17. The process as claimed in claim 1, characterized in that the duration of grafting is between 4 and 24 hours.

18. An inorganic substrate coated with an organic monolayer, obtained by the process as claimed in any one of claims 1 to 17.

19. An inorganic substrate coated with an organic monolayer obtained by the process as claimed in claim 12, characterized in that the monolayer consists of alkylene radicals attached by —Si—H₂O—Si— bonds in which the SiH₂ groups are characterized by a vibration band √Si—H at 2150 cm⁻¹.
